(19) United States
(12) Patent Application Publication
(10) Pub. No.: US 2018/0010254 A1
(43) Pub. Date: Jan. 11, 2018

(54) PICKLING PRODUCTION LINE AND APPLICATION THEREOF FOR MAGNESIUM ALLOY WASTE MATERIAL

(71) Applicant: Heyi TAN, Xiangtan (CN)

(72) Inventors: Heyi TAN, Xiangtan (CN); Lunyuan TANG, Xiangtan (CN)

(73) Assignee: HUNAN S.R.M SCIENCE AND TECHNOLOGY CO., LTD, Xiangtan (CN)

(21) Appl. No.: 15/676,992

(22) Filed: Aug. 14, 2017

Related U.S. Application Data
(63) Continuation of application No. PCT/CN2015/073172, filed on Feb. 16, 2015.

(51) Int. Cl. C23G 3/00; F26B 15/10; C23G 1/12; B08B 15/02; B08B 3/08; B08B 3/04; C22B 26/22; B08B 3/02; F26B 21/00

(52) U.S. Cl. CPC C23G 3/00; C22B 26/22; F26B 15/10; C23G 1/12; B08B 3/022; B08B 15/02; B08B 3/08; B08B 3/047; F26B 21/001

(57) ABSTRACT

A pickling production line comprises a material-holding apparatus, a pickling zone, and a water wash zone; the pickling zone and the water wash zone are independently arranged; the material-holding apparatus is filled with magnesium alloy waste, and self-rotates successively in the pickling zone and the water wash zone for pickling and water washing respectively. In the pickling production line for magnesium alloy waste material, the magnesium alloy waste material is pickled and washed more thoroughly; coatings and impurities on the surface of the magnesium alloy waste material are removed, the efficiency of the cleaning and the consistency of the cleaning are high, and each piece of equipment in the entire production line is connected in a compact manner; the invention has a high degree of automation, low environmental pollution, conserves resources, is highly efficient in production, and is suitable for the bulk pickling and cleaning of magnesium alloy waste material.

### CROSS REFERENCE TO RELATED APPLICATIONS

This application is a continuation of PCT/CN2015/073172 filed Feb. 16, 2015, which is incorporated herein by reference.

### BACKGROUND OF THE INVENTION

### 1. Technical Field

The present invention relates to production lines for recycling and processing metals, and more particularly to pickling production line and application thereof for magnesium alloy waste material, which belongs the art of magnesium metal producing industry.

### 2. Description of Related Art

Magnesium is one of the abundant light metal elements on the earth. Magnesium has a specific weight of 1.74 g/cm³, equal to only two-thirds of that of aluminum, two-fifths of that of titanium, or one-fourth of steel. Magnesium alloys are alloys made of magnesium as the base and other elements. Magnesium alloys are small in density and high in specific strength and specific stiffness, while having advantages such as possessing great electromagnetic shielding ability, damping performance, vibration reducing capacity, and cutting processability, requiring low processing costs because the energy it consumes for processing is only 70% of that required by aluminum alloy, and being easy to recycle. For these reasons, magnesium and magnesium alloy are considered as green engineering materials of the 21^{st} century, and have been extensively applied to industries such as automobiles, aerospace, 3 C, power tools, optic equipment, sporting goods and telecommunication. Presently, as the global manufacturing industry goes toward lightweight, low energy consumption, and low pollution, magnesium alloy components have replaced plastic, aluminum alloy, and even steel ones in many applications.

According to China Nonferrous Metals Industry Association, China produced 769.7 thousand tons of raw magnesium in 2013, namely 10.22% more than the same period in the previous year, and 297.8 thousand tons of magnesium alloy, namely 43.52% more than the same period in the previous year. However, rapid growth of output of magnesium alloy necessarily brings about sharp increase of magnesium alloy waste material. Fortunately, magnesium alloy waste material is highly recoverable and less energy consuming. Its recovery rate is more than 95%, and the energy consumption for recycle is only 5% to 10% of that for raw magnesium production. Therefore, reasonable recovery and reuse of magnesium alloy waste material directly influence the rationally and sustainability of development of magnesium alloy industries, and are of importance to reducing environmental pollution, conserving energy, as well as lowering costs and extending life cycle of magnesium alloy.

As a starting point of recycling magnesium alloy waste material, magnesium alloy waste material is firstly rated. Recycling waste, discarded material, scrap and swarf of magnesium alloy ensures the full utilization of recycled materials, helping to lower production costs. Waste of magnesium and magnesium alloy has eight grades in a draft of international classification standards, as shown in Table 1 below.

TABLE 1
Grades of Waste of Magnesium and Magnesium Alloy

| Grade | Description | Source | Example |
|---|---|---|---|
| 1 | Cleaned and | Produced in | Cakes in runners, |
| | sorted waste | die-casting | sprue, burr, |
| | | processes | flashing and |
| | | | scrapped parts |
| 2 | Cleaned and | Produced in | Waste castings |
| | sorted waste, mixed | die-casting | containing steel |
| | with wooden | processes | inclusions |
| | inclusions and steel | | |
| | inclusions | | |
| 3 | Grade 1 or 2 waste | Produced in | Rejected |
| | coated or smeared | die-casting | castings |
| | with paint or | processes | |
| | greasiness | | |
| 4 | Dry and clean | Produced in | Machined |
| | machined debris | die-casting | debris and |
| | and cutting scrap | processing | cutting scrap |
| | | without | |
| | | lubricator | |
| 5 | Machined debris and | Produced in die- | Machined debris |
| | cutting scrap smeared | casting processing | and cutting scrap |
| | with oil and water | with oil or oil-water | |
| | | emulsion lubricator | |
| 6 | Slag free of salts | Produced in cleaning | Slag |
| | | smelting furnaces | |
| 7 | Slag containing salts | Produced in mold- | Slag |
| | | casting processes | |
| | | under dry condition | |
| 8 | Waste other than those | | |
| | of Grades 1 through 7; | | |
| | alloy of different | | |
| | designations mixed | | |
| | and stored for long | | |
| | time | | |

Recycle of magnesium alloy waste material on one hand is to recycle inactive or discarded magnesium alloy products, on the other hand is to recycle waste and cutting scrap of magnesium and magnesium alloy. Grades 1 through 7 cover waste and cutting scrap of magnesium and magnesium alloy. The cleaned and sorted waste of Grade 1 can be smelted directly. The waste of Grade 2 that has been cleaned and sorted yet mixed therein with wooden inclusions and steel inclusions can only be smelted when the inclusions have been removed. The waste of Grade 3 that is actually waste of Grade 1 or 2 but further coated or smeared with paint and greasiness must have the paint and greasiness removed before smelted. As to the waste of Grade 4 and Grade 5, such as cutting scrap, machined debris, and chips that contain more oxides and are seriously contaminated, their recycle must be handled with special care. Grade 6 and Grade 7 refer to slag which is too small yet with large specific surface area to be reclaimed, sorted, remelted and regenerated in practice, and waste of these two grades is presently not recycled. As to Grade 8, namely random mixtures of various designation of alloys coming from inactive or discarded magnesium alloy products, which include cars' wheel hubs, steering wheels, engine cylinder caps, airplane bodies, airplane skin, computer casing and camera casing, summing more than 200,000 tons/year. For optimizing inactive or discarded magnesium alloy products' performance and service life, surface treatments such as anodic oxidation, chemical plating, electroplating and surface coating are usually applied during production. Besides, magnesium alloy products in use can accumulate mass greasiness, dirt and oxide layers containing such greasiness and dirt. These coating, greasiness, dirt and oxide layers containing such greasiness and dirt on surface of the magnesium alloy are extremely harmful to recycling of magnesium alloy products. Thus a proper pretreatment should be performed to effectively remove the coating and impurities on the waste material surface during recycling the inactive or discarded magnesium alloy products.

Pickling is an important procedure for removing the coating and impurities on the waste material surface in the pretreating process. That is because all of the oxide layer generated by anodic oxidation, metal coating generated by chemical plating or electroplating, and oxide coating generated during use of the magnesium alloy products can be removed by pickling process, and thus the coating and impurities on the waste material surface can be removed.

However, in the prior art, magnesium alloy waste material is usually placed into the acid solution for soaking in the pickling process. For example, China Patent No. CN 101947705A discloses methods for producing magnesium alloy welding wires by adopting magnesium alloy foundry scraps, wherein soaking is directly used for pickling and water rinse. Wherein the magnesium alloy waste material is stationary in the acid liquid or water, the coating and impurities thereon keep adhering to its surface even corroded by the acid. Thus such simply soaking could not sufficiently clean the magnesium alloy waste material, leading to poor pickling effectiveness and consistency, and incomplete water rinsing.

Considering the problem caused by soaking for pickling and water rinsing, there are some documents disclose the idea of dynamic pickling and water rinsing for magnesium alloy waste material allowing dynamic and thus complete contact between the material and the acid liquid or water. The known dynamic pickling and water rinsing schemes are adding an agitator to stir the magnesium alloy waste material and acid liquid. For example, China Patent No. CN 101736160A also discloses a method for recovering low-level waste of magnesium alloy. The method uses stainless steel containers to receive waste and acid liquid, and uses an agitator to pickle with agitation for three times, each lasting for 30 min, and then wash rinsing with agitator in the same way for three times. However this scheme also exists the following problem: 1) because the agitator are arranged inside the container, the diameter of the stirrer could not larger than that of the container; and only parts of the magnesium alloy waste material inside the container could be stirred, which leading to unevenly pickling and water rinsing effect in the corresponding process, and incompletely clearing of coating and impurities away from surface of the magnesium alloy waste material; 2) the agitator is easy to get stuck by the magnesium alloy waste material during agitation; and the agitator will be deformed due to drag force of the solution and weight force of the magnesium alloy waste material during agitation; 3) long pickling duration leads to serious corrosion of the magnesium alloy waste material by acid, leading to great loss of waste material during pickling and water rinsing.

What's more, the existing pickling and water rinsing methods also have the following defects:

1) In the pickling production line for magnesium alloy waste material, the concentration of the acid could not be kept over the long duration of pickling. Impurities in the magnesium alloy waste material are continuously get into the pickling liquid, which reduces concentration of the pickling liquid, weakens the pickling intensity and thus lead to incompletely pickling of the magnesium alloy waste material.

2) Third, magnesium alloy waste material after pickling or alkali wash goes into subsequent processes directly, which may bring about gas inclusion to the subsequent processes, and make reprocessing of magnesium alloy waste material dangerous and lowers utilization.

3) The prior art fails to handle the waste residue, waste water, and waste gas generated in magnesium alloy waste material's recycling process in a proper and sustainable manner, and this causes environmental pollution and resource wasting.

To sum up, there is a need for a pickling production line that ensures cleaning up the harmful impurities on surface of the magnesium alloy waste material, optimizes utilization of magnesium alloy waste material, rationally treats the waste acid and gas, and accomplishes safe and sustainable pickling for magnesium alloy waste material.

### SUMMARY OF THE INVENTION

In view of the problems of the prior art, one objective of the present invention is to provide a pickling production line for magnesium alloy waste material, wherein improved equipment in the pickling production line allows dynamically washing the magnesium alloy waste material during pickling and water rinsing, thereby achieving washing consistency and sufficiency of the magnesium alloy waste material in pickling and water-rinse processes, increasing washing efficiency, shortening overall washing time and minimizing loss of the magnesium alloy waste material during these processes.

For achieving the foregoing objectives, the present invention adopts the following technical schemes.

A pickling production line for magnesium alloy waste material comprises: a batch-containing device, a pickling area, and a water-rinse area, in which the batch-containing device contains the magnesium alloy waste material, and the pickling area is independent of the water-rinse area;

in which the batch-containing device sends the magnesium alloy waste material it contains to the pickling area and the water-rinse area for pickling and water rinse in sequence.

Another objective of the present invention is to provide a pickling production line for magnesium alloy waste material, so as to achieve better pickling process effect. The pickling production line comprises a batch-containing device, a pickling area, a water-rinse area, and a hoisting device, in which the batch-containing device contains the magnesium alloy waste material, and the pickling area is separated from the water-rinse area, while the hoisting device drives the batch-containing device to travel between the pickling area and the water-rinse area;

in which the hoisting device drives the batch-containing device containing the magnesium alloy waste material therein to enter the pickling area and the water-rinse area for pickling and water rinse in sequence

Preferred schemes for any of the foregoing pickling production lines are described below.

Preferably, the magnesium alloy waste material comes from a discarded magnesium alloy product, which is one or any mix of cars' wheel hubs, steering wheels, engine cylinder caps, airplane bodies, airplane skin, computer casing, mobile phone casing, camera casing, and power tool casing.

Preferably, the magnesium alloy waste material is pickled in the pickling area and rinsed in the water-rinse area, respectively, as the batch-containing device rotates.

Preferably, the batch-containing device is a power-driven drum, which contains the magnesium alloy waste material and is provided with a rotatory shaft passing through it. For ensuring the drum's stable rotation, the rotatory shaft is fixedly connected with the drum, preferably by welding, and the rotatory shaft is such arranged that it is coaxial with the drum's center line, and the drum is rotated by the rotatory shaft's rotation. At this time, magnesium alloy waste material in the drum randomly turns with the drum's movement, so as to ensure sufficient contact between the magnesium alloy waste material and washing liquid. The impurities on the magnesium alloy waste material's surface (especially those in grooves) can be easily taken off when the waste is turning, so as to maintain washing consistency and improve washing efficiency.

More preferably, the drum is provided with a plurality of through holes, whose diameter is smaller than a lump diameter of the magnesium alloy waste material, preferably smaller than the maximum diameter of the smallest lump of magnesium alloy waste material. This is to prevent the magnesium alloy waste material from coming out from the through holes during pickling and rinse, thereby reducing loss, and this allows washing liquid in the pickling area and the water-rinse area to enter the drum through the through holes and sufficiently contact the magnesium alloy waste material in the drum, thereby ensuring the magnesium alloy waste material's homogeneity during pickling and water rinse, and reducing the overall time for pickling and water rinse.

More preferably, the through hole has a diameter of 5 to 30 mm.

More preferably, the drum is a cylinder or a regular polygonal column.

More preferably, the drum is made of titanium alloy boards, engineering plastic board or other acid proof and high strength boards, preferable made by soldering titanium alloy boards.

More preferably, the drum includes a material port and a lid, in which the lid is operable to open or close the material port.

More preferably, the lid movably covers the material port. In other words, for loading or unloading the drum, the lid is open and the material port is accessible, and when rotating the drum, the lid is shut down, and the drum is allowed to rotate only when the material port is closed.

More preferably, the lid has its one side moveably connected to the drum's wall at one side of the material port, preferable by means of hinges.

More preferably, the drum has a handle that is coaxial with or parallel to the drum's center line. As one preferred mode, the handle is disposed outside the drum and fixedly connected to the drum. By rotating the handle, the drum's rotation is controlled to orientate the material port on the drum for loading or unloading. In particularly, the material port faces upward for loading, and faces downward for unloading.

More preferably, the drum is driven by a drive motor. The drive motor is disposed at one end of the pickling area and/or the water-rinse area. The drive motor drives a rotatory shaft that rotates the drum. As a preferred mode, the drive motor drives the drum to rotate by means of a pair of transmission gears that are disposed at the rotatory shaft and the drive motor, respectively, which engage with each other. The drive motor drives the transmission gear pair to rotate, and in turn rotates the rotatory shaft to drive the drum. As a more preferred mode, there are two drive motors, each disposed at one end of the pickling area and the water-rinse area. The two drive motors drive the drum in the same manner, so the paired gear wheels are to structurally identical. As one preferred mode, the transmission gear is located at one end of the rotatory shaft.

More preferably, the rotatory shaft has its two ends each provided with a rolling bearing for reducing drag when the drum rotates.

More preferably, the rotatory shaft has its two ends each provided with a hoisting element aligned and moveably connected to the hoisting device. As one preferred mode, the hoisting element is a bearing mounted around the rotatory shaft, and has a diameter not greater than the hoisting device's hook's diameter.

As one preferred mode, the rotatory shaft is provided or installed with the transmission gear, the rolling bearing, the hoisting element, the drum, the hoisting element, and the rolling bearing in sequence.

More preferably, the rotatory shaft is made of titanium alloy or other acid-proof metals or alloy materials thereof.

Preferably, the hoisting device is power driven a hoisting unit equipped with hooks. The hooks work with the batch-containing device's hoisting elements to help the batch-containing device to perform material loading, entering the pickling area, exiting the pickling area, entering the water-rinse area, exiting the water-rinse area or material unloading in sequence. With the hoisting device moving the drum in the pickling area and the water-rinse area, less human labor is require and automatic control is achieved.

More preferably, when the hooks and the rotatory shaft are moveably connected, the hoisting device can drive the batch-containing device. More preferably, the hoisting device can only be started when the hooks and the rotatory shaft are aligned and engaged.

More preferably, the hoisting unit may be realized using a crane known in the art, and is not of great significance to the present invention. An exemplificative structure thereof will be described below.

Another object of the invention is to provide a pickling production line for magnesium alloy waste material, which ensure that the magnesium alloy waste material is in sufficient contact with washing liquid in the pickling and water-rinse processes, the inventor basing on any of the foregoing configurations of the pickling production line, makes a structural improvement in the pickling area and the water-rinse area, so that the pickling area and the water-rinse area are adapted to the batch-containing device, thereby allowing the magnesium alloy waste material to contact acid liquid sufficiently in the pickling process to have oxidize layers and impurities on its surface removed and to receive double water-rinse in the water-rinse process so as to thoroughly clean residual acid and residue on the magnesium alloy waste material's surface.

Preferably, the pickling area includes a pickling bath, an acid-in channel, and an acid-out channel. The acid-in channel and the acid-out channel pass through the pickling bath and are communicated with the pickling bath, respectively. As a preferred mode, the joint between the acid-in channel and the pickling bath is higher in altitude than the joint between the acid-out channel and the pickling bath. In other words, the acid-in channel is located higher than the acid-out channel. The acid-in channel and the acid-out channel control charging and discharging of acid solution to and from the pickling bath, so as to ensure that the magnesium alloy waste material contacts acid liquid sufficiently in the pickling process and has oxide layers and impurities on its surface well removed.

More preferably, the acid-out channel passes through the lateral wall of the pickling bath. As a preferred mode, the acid-out channel passes through the pickling bath's lateral wall and the acid-out channel's wall is tangent to the pickling bath's bottom.

More preferably, the acid-in channel passes through the pickling bath's lateral wall.

More preferably, the acid-in channel is a double acid-in channel.

More preferably, the double acid-in channel includes two side tubes extending from the same main tube. The two side tubes pass through the pickling bath's different lateral walls, respectively, so that during acid charging the acid solution in the pickling bath can be prepared more homogeneous.

More preferably, the two side tubes are disposed at the pickling bath's two opposite lateral walls, respectively.

Preferably, the pickling bath has a capacity not smaller than the batch-containing device's volume. In other words, the pickling bath's capacity is greater than the drum's volume.

More preferably, the pickling bath's dimension in its length direction is 20 to 50 cm greater than the drum's dimension in its height direction.

More preferably, the pickling bath's dimension in its width direction is 20 to 100 cm greater than the drum's diameter.

More preferably, the pickling bath's dimension in its height direction is 10 to 100 cm greater than the drum's radius.

More preferably, the pickling bath is provided with a lid to be used when the drum is not in the pickling bath in order to prevent the acid solution from volatilization, to minimize material loss, and to reduce atmospheric pollution.

More preferably, the pickling bath is made of an acid-proof material, such as engineering plastic or fiber-reinforced plastic.

Preferably, the pickling bath has two sides thereof each provided with a force-bearing seat, so that the force-bearing seats are coaxial with a center line of the pickling bath in a length direction thereof. As one preferred mode, the force-bearing seat is a concave seat matching the rotatory shaft in shape. When the drum is in the pickling area for pickling, the rotatory shaft's two rotating bearings are received by the two force-bearing seats, respectively, thereby securing the relative position between the drum and the pickling bath, and reducing drag against rotation of the drum (the batch-containing device). In addition, the batch-containing device can only rotate when it is settled on the force-bearing seats so as to further ensure safe operation.

Preferably, the water-rinse area includes a rinse unit, a material unloading unit, and a spraying unit. The pickled magnesium alloy waste material passes through the rinse unit, the material unloading unit, and the spraying unit in sequence. Since the rinse unit and the spraying unit provide the magnesium alloy waste material with double water-rinse, the magnesium alloy waste material is allowed to contact washing liquid sufficiently in the water-rinse process performed in the water-rinse area, so as to have residual acid and residue on the magnesium alloy waste material's surface removed thoroughly.

Preferably, the rinse unit is a rinse bath, and the drum of the batch-containing device rotates in the rinse bath to rinse the magnesium alloy waste material.

More preferably, the rinse bath's capacity is not smaller than the batch-containing device's volume.

More preferably, the rinse bath's depth is greater than the drum's radius, so as to facilitate the drum's rotation in the rinse bath.

More preferably, the rinse bath has two ends thereof each provided with a force-bearing seat. The force-bearing seats are such installed that they are coaxial with the rinse bath's center line in its length direction. As one preferred mode, the force-bearing seats are concave seats matching the rotatory shaft in shape. When the drum is rinsing in the rinse bath, the rotatory shaft's two rotating bearings are settled on the two force-bearing seats, respectively, thereby securing the drum with the rinse bath in position and reducing drag against the drum's rotation.

Preferably, the material unloading unit is a discharge hopper. When the drum is moved by the hoisting device from the rinse bath to right above the material unloading unit, by rotating the drum's handle to make the material port face downward and opening the drum lid, the material falls into the discharge hopper, thereby achieving material unloading.

Preferably, the spraying unit includes a water pressurizer, water nozzles, a spraying conveyer, and a spraying hood. The water nozzles and the water pressurizer are disposed at one side of the spraying conveyer. The water nozzles and the water pressurizer are connected. The magnesium alloy waste material in the spraying unit is rinsed against by the water nozzles. The spraying hood is a three-side hood and covers the spraying conveyer's two laterals and top, thereby preventing the magnesium alloy waste material from falling when conveying by the spraying conveyer and washing by the water nozzles, reducing loss, and preventing sprinkling water from splash.

More preferably, the spraying conveyer is a vibrating conveyer board. As one preferred mode, the conveyer board is electrically connected to a vibration motor, and is meshed and sloping, so as to make the material on the vibrating conveyer board move forward evenly under vibration, thereby preventing the material from being piled on the spraying conveyer. As a more preferred mode, the conveyer board has a slope of 5-30 degrees. The sprinkling conveyer has its two sides equipped with retaining plates for preventing the material from falling.

More preferably, the material unloading unit is disposed at one end of the spraying unit. Preferably it is disposed at the spraying conveyer's one end. The magnesium alloy waste material is unloaded from the discharge hopper material and transferred by the spraying conveyer to enter the spraying unit for secondary water-rinse.

More preferably, the spraying unit further includes a collecting tube. The collecting tube has its one end disposed below the spraying conveyer and has its opposite end communicated with the rinse unit's rinse bath. The collecting tube collets waste water generated in the sprinkling process for reuse as aqueous solution in the rinse bath.

Preferably, the pickling production line further comprises a dewatering-drying device, for dewatering and desiccating the pickled and water-rinsed material. The dewatering-drying device includes an air-blowing unit and a hot-air drying unit that are connected to each other but not communicated with each other. In addition, the air-blowing unit is connected to the spraying unit in the water-rinse area. The magnesium alloy waste material after the spraying unit passes through the air-blowing unit and the hot-air drying unit in sequence for dewatering and desiccation, so as to speed up liquid evaporation at the magnesium alloy waste material's surface, thereby ensuring safety in the subsequent processes, and reducing the magnesium alloy waste material's oxidization and the melt's gas inclusion.

More preferably, the air-blowing unit includes an air-blowing compressor, an air-blowing conveyer, air-blowing nozzles, and an air-blowing hood. The air-blowing hood is a three-side hood and covers the air-blowing conveyer's two laterals and top. The air-blowing nozzles are arranged above the air-blowing conveyer and inside the air-blowing hood. The air-blowing conveyer has its one end connected to the spraying unit in the water-rinse area, and has its opposite end connected to the hot-air drying unit. The air-blowing compressor supplies the air-blowing nozzles with pressurized air. The magnesium alloy waste material in the air-blowing unit is transferred by the air-blowing conveyer and treated by the compressed air gushing from the air-blowing nozzles, so as to have liquid at is surface preliminarily removed, thereby reducing working load in the hot-air drying process.

More preferably, the hot-air drying unit includes a hot-air compressor, a heat source, hot-air nozzles, a heat-baking conveyer, and a heat-baking hood. The heat-baking hood is a three-side hood and covers the heat-baking conveyer's two laterals and top. The hot-air compressor and the heat source are connected. The hot-air nozzles are disposed above the heat-baking conveyer and inside the heat-baking hood. The heat-baking conveyer has its one end connected to the air-blowing unit's air-blowing conveyer. The hot-air drying unit works as below. The pressurized air generated by the hot-air compressor is heated by the heat source into pressurized hot air. The hot-air compressor generates hot air and makes it gush from the hot-air nozzles. The magnesium alloy waste material transferred by the heat-baking conveyer is dried by the pressurized hot air coming from the hot-air nozzles, so as to evaporate liquid at the magnesium alloy waste material's surface quickly. Therein, the heat source may be one known in the art, such as electric heating or gas heating, as long as it is energy-conserving and environmentally friendly.

More preferably, the hot-air drying unit further includes an air extractor. The air extractor is disposed at one side of the heat-baking conveyer for quickly exhausting the gas evaporated from the magnesium alloy waste material's surface, thereby preventing gas condensation and secondary contamination.

Another object of the invention is to provide a pickling production line for magnesium alloy waste material. For maintaining the acid concentration in a predetermined range throughout the magnesium alloy waste material's pickling process, so as to ensure desired pickling effectiveness, the inventor of the present invention, on the basis of any of the foregoing configurations of the pickling production line, adds an automatic acid-changing/refilling system, which monitors variation of the acid liquid throughout the pickling process and automatically adds or changes acid, thereby maintaining the acid concentration in a predetermined range for stable pickling intensity to the magnesium alloy waste material and in turn the pickling effectiveness. Accordingly, the automatic acid-changing/refilling system includes a pH meter, an Mg²⁺ concentration detector, an electric control valve, an acid-metering pump, a water-metering pump, and a control unit. The portion including the pH meter, the Mg²⁺ concentration detector, and the electric control valve are disposed inside the pickling bath. The portion including the acid-metering pump, the water-metering pump, and the control unit are disposed outside the pickling bath. The pH meter, the Mg²⁺ concentration detector, the electric control valve, the acid-metering pump, and the water-metering pump are in data connection with the control unit, preferable connected in parallel to each other. The pH meter regularly measures acidity of the acid solution in the pickling bath, and the Mg²⁺ concentration detector measures the Mg²⁺ concentration in the pickling bath in a real-time manner. The pH meter and Mg²⁺ concentration detector send signals to the control unit according to their measurement, the control unit controlling operations of the electric control valve, the acid-metering pump, and the water-metering pump; the electric control valve controlling acid discharging from the acid-out channel, and the acid-metering pump controlling acid charging from the acid-in channel. More preferably, when a pH value measured by the pH meter is below a predetermined pH threshold, the control unit after received the signals controls the acid-metering pump to start and the acid-in channel to open for adding acid to the pickling bath.

More preferably, when a detected value of the Mg²⁺ concentration detector is over a predetermined Mg²⁺ concentration threshold, the control unit after received the signals opens the electric control valve and the acid-out channel for automatic acid discharge, after which the electric control valve is closed while the control unit starts the acid-metering pump and the water-metering pump to prepare the acid solution again according to a predetermined ratio.

As a more preferred mode, the pH value ranges between 0 and 7, and the Mg²⁺ concentration value ranges between 0.0 and 3.0 mol/L.

Another objective of the present invention is to provide a pickling production line for magnesium alloy waste material. For minimizing environmental pollution and conserving resources, the inventor of the present invention, on the basis of any of the foregoing configurations of the pickling production line for magnesium alloy waste material, adds an environmental protection system, which processes waste gas and waste acid generated throughout the pickling production line, thereby protecting the environment, while conserving resources. Accordingly, the environmental protection system includes a waste-gas processing unit and a waste-acid processing unit that are installed separately to process waste gas and waste acid generated in the entire pickling production line, respectively.

Preferably, the waste-gas processing unit is an acid-gas spray column for processing acid gas, and the acid-gas spray column includes a blower, filler, a spraying device, a defogging device, a sprinkling liquid circulating pump, and a absorption column, thereby achieving zero acid gas discharge after acid gas neutralization, and realizing environmentally friendly processing of waste gas.

More preferably, the waste-gas processing unit further includes a sealed glass chamber, and the exhauster is disposed inside the glass chamber to exhaust acid gas in the glass chamber into the acid-gas spray column.

More preferably, the rinse units in the pickling area and in the water-rinse area are both disposed in the glass chamber, thereby preventing acid gas from escaping from the pickling area and rinse unit, and in turn minimizing environmental pollution.

More preferably, the glass chamber has a batch-in gate, a batch-out gate, and a control sensor. The control sensor opens or closes the batch-in gate and the batch-out gate. When magnesium alloy waste material as the raw material enters the pickling production line, the batch-in gate opens automatically, and automatically closes when material loading is finished. When outputting the magnesium alloy waste material as the raw material has been processed by the entire pickling production line and, the batch-out gate opens automatically and closes automatically when outputting ends.

Preferably, the waste-acid processing unit includes a neutralization pit, a filter, an evaporation crystallizer, and a drier connected in sequence, in which waste acid in the pickling area is processed by the neutralization pit, the filter, the evaporation crystallizer, and the drier in sequence and converted into dry magnesium salts, so as to eliminate waste acid discharge, to protect the environment, and to conserve resources. Therein, the neutralization pit and the acid-out channel are communicated.

Another object of the present invention is to provide an application of a pickling production line for magnesium alloy waste material, the pickling production line together with a post processing system for magnesium alloy waste material becomes a recycling and processing production line for magnesium alloy waste material, wherein the pickling production line is used for pickling to remove impurities on the surface of the magnesium alloy waste material.

Preferably, the recycling and processing production line for magnesium alloy waste material is used to produce GB-standard magnesium alloy ingots, wherein the magnesium alloy waste material processed by pickling production line is then treated by the post processing system to obtain GB-standard magnesium alloy ingots.

As compared to the existing technologies, the pickling production line for magnesium alloy waste material of the present invention has the following advantages:

1. The magnesium alloy waste material is contained in a hollow drum and all the magnesium alloy waste materials in the drum have equal opportunities to contact acid liquid and water during rotating, thereby ensuring homogeneity of pickling and water-rinse, shortening overall washing time;

2. The magnesium alloy waste material in the drum is separated from the outside. When rotating the drum the magnesium alloy waste material could not leave out the drum, thereby reducing loss of the magnesium alloy waste material, and increasing utilization of the magnesium alloy waste material;

3. The magnesium alloy waste material in the drum does not directly contact with the drive motor and has no impact on rotation of the drum;

4. The pickled magnesium alloy waste material is double washed by water. That is to say, the water-rinse process involves rinse and sprinkling, so as to clean up the impurities and residual acid liquid from the magnesium alloy waste material's surface, thereby improving cleanliness and reducing loss of the magnesium alloy waste material;

5. Drying devices are introduced into the pickling production line, including air drying and hot air drying, so as to speed up liquid evaporation at the magnesium alloy waste material's surface after water rinse, thereby ensuring safety in the subsequent processes, minimizing gas inclusion, lowering autoxidation and increasing utilization of the magnesium alloy waste material;

6. The pickling area is added with a automatic acid adding and changing system that performs regular monitoring and automatically adds or changes acid according to variation to maintain the acid liquid's PH value and the Mg²⁺ concentration in a predetermined range, thereby ensuring pickling effectiveness;

7. The pickling production line is added with an environmental protection system, which processes waste gas and waste acid generated in the pickling production line, thereby protecting the environment, and conserving resources.

To sum up, the disclosed production line for magnesium alloy waste material completely pickles and water rinses the magnesium alloy waste material, cleans up the coating and impurities on the surface there of, and has good washing consistency and washing efficiency. The devices in the whole production line are compactly connected, and has high automaticity, little environmental pollution and high production efficiently, and conserves resources. It is suitable for batch pickling process for magnesium alloy waste material, thereby having promising extensive applications.

### BRIEF DESCRIPTION OF THE DRAWINGS

FIG. 1 is a schematic drawing of a pickling production line for magnesium alloy waste material according to one preferable mode of the present invention;

FIG. 2 is a schematic drawing of batch-containing device in the pickling production line for magnesium alloy waste material according to the present invention;

FIG. 3 is a schematic drawing of a water-rinse area in pickling production line for magnesium alloy waste material of the present invention;

FIG. 4 is a flowchart of an automatic acid adding and changing device in pickling production line for magnesium alloy waste material of the present invention;

FIG. 5 is a flowchart of the pickling production line for magnesium alloy waste material of the present invention;

### DETAILED DESCRIPTION OF THE INVENTION

The invention as well as a preferred mode of use, further objectives and advantages thereof will be best understood by reference to the following detailed description of illustrative embodiments.

Any equipment or component whose model is not specified in the following modes can be realized using a commercially available counterpart thereof known in the art, as long as it supports the disclosed pickling production line for magnesium alloy waste material to function normally, and the present invention places no limitation thereon.

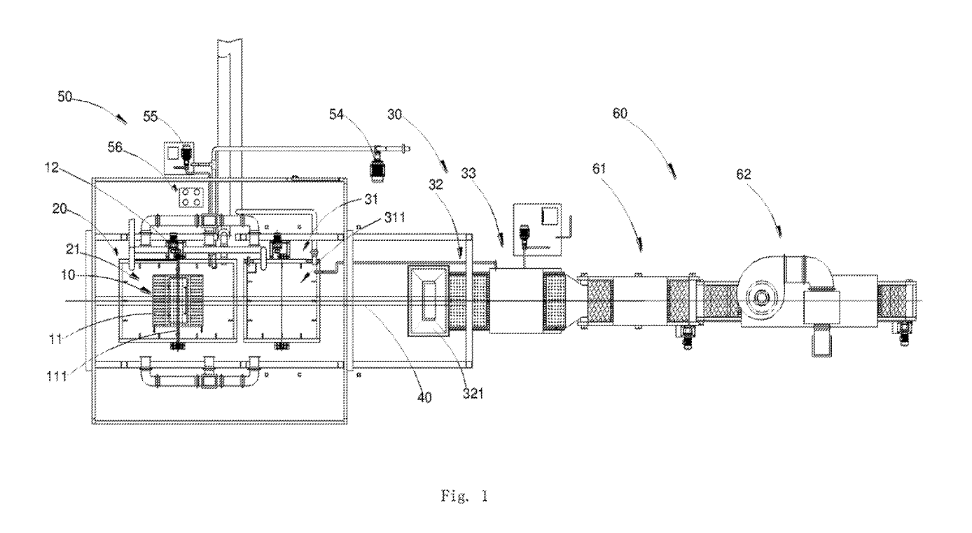

FIG. 1 through FIG. 5 illustrate a pickling production line for magnesium alloy waste material according to one preferable mode of the present invention. A pickling production line together with a post processing system for magnesium alloy waste material becomes a recycling and processing production line for magnesium alloy waste material. Wherein after pickling the magnesium alloy waste material to remove impurities on its surface in the pickling production line, it is then treated by the post processing system to directly product GB-standard magnesium alloy ingots, thereby improving the recovery rate of magnesium alloy waste material. As shown in FIGS. 1-5, the pickling production line includes a batch-containing device 10, a pickling area 20, a water-rinse area 30, a hoisting device 40, an automatic acid-changing/refilling system 50, a dewatering-drying device 60 and an environmental protection system 70. The automatic acid-changing/refilling system 50 maintains acid liquid in the pickling area 20 at certain concentration. The pickling area 20 and the water-rinse area 30 are separated. The batch-containing device 10 serves to contain the magnesium alloy waste material. The hoisting device 40 moves the batch-containing device 10 between the pickling area 20 and the water-rinse area 30. The dewatering-drying device 60 dries the magnesium alloy waste material that has been processed in the pickling area 20 and the water-rinse area 30. The environmental protection system 70 processes waste gas, magnesium slag and waste acid generated throughout the pickling production line.

The travel of the magnesium alloy waste material is described below. The magnesium alloy waste material is fed into the batch-containing device 10, and the hoisting device 40 drives the batch-containing device 10 to take the magnesium alloy waste material into the pickling area 20 and the water-rinse area 30 in sequence for pickling and water-rinse. Afterward, the dewatering-drying device 60 performs dewatering and desiccation. The hoisting device 40 controls movement of the batch-containing device 10. The hoisting device 40 moves the batch-containing device 10 between the pickling area 20 and the water-rinse area 30. The magnesium alloy waste material is pickled and rinsed as the batch-containing device 10 rotates in the pickling area 20 and the water-rinse area 30, respectively. The magnesium alloy waste material in the batch-containing device 10 is separated from external foreign objects, while washing liquid of the pickling area 20 and the water-rinse area 30 can enter the batch-containing device 10 to contact the magnesium alloy waste material therein.

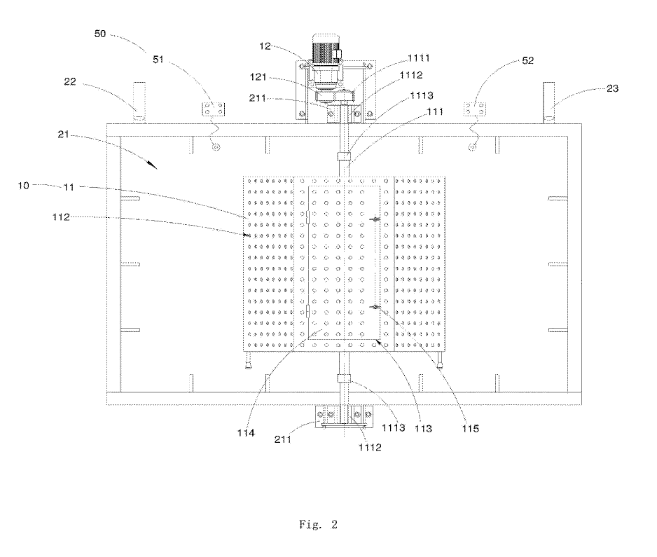

FIG. 2 is a schematic drawing of a batch-containing device in the pretreatment system of the pickling production line for producing GB-standard magnesium alloy ingots from magnesium alloy waste material of the present invention. As shown in FIG. 2, the batch-containing device 10 includes a drum 11 and a drive motor 12. The drum 11 contains the magnesium alloy waste material and has a rotatory shaft 111. The rotatory shaft 111 passes through the drum 11, and the connection between them are made by welding, so that the drum 11 and the rotatory shaft 111 can rotate synchronously, and thus realizing driving the drum 11 by rotating the rotatory shaft 111. The drive motor 12 is disposed at one end of the pickling area 20. The drive motor 12 rotates the drum 11 by driving the rotatory shaft 111 to rotate. At this time, the magnesium alloy waste material in the drum 11 get well pickled and rinsed in the pickling area 20 and the water-rinse area 30. The magnesium alloy waste material in the drum 11 rotates with the drum 11, thereby ensuring that the magnesium alloy waste material and washing liquid contacts sufficiently. Meanwhile, impurities on the magnesium alloy waste material's surface (especially in grooves) are more likely to come off during the rolling process, thereby ensuring washing consistency and increasing washing efficiency.

The drum 11 is a cylinder or a regular polygonal column made by welding titanium alloy boards, engineering plastic boards or other acid-proof and high-strength boards together. The drum 11 is provided with plural through holes 112 distributing across the wall defining the drum 11. The through hole 112 has a diameter smaller than the lump diameter of the minimum lump of the magnesium alloy waste material. The through hole 112 has a diameter of 5 to 30 mm, so as to prevent the magnesium alloy waste material from coming off from the through holes 112 in the pickling and water-rinse processes, thereby minimizing loss of the magnesium alloy waste material while allowing solution in the pickling area 20 and the water-rinse area 30 to enter the drum 11 through the through holes 112 to sufficiently contact the magnesium alloy waste material. This ensures homogeneity of the magnesium alloy waste material throughout the pickling and water-rinse processes, and shortens the overall pickling and water-rinse time.

The drum 11 includes a material port 113 and a lid 114. The lid 114 opens and closes the material port. The lid 114 is fixed to the drum's wall outside the material port 113 through hinges so that it can cover the material port 113. The magnesium alloy waste material enters and exits the drum 11 through the material port 113. For material to enter or exit, the lid 114 and in turn the material port 113 are open. During rotation of the drum 11, the lid 114 is shut down to close the material port 113. The drum 11 further includes a handle 115. The handle 115 is coaxial with or parallel to the center line of the drum 11. The handle 115 is arranged outside the wall of the drum 11 and fixedly attached to the drum 11. By rotating the handle 115, rotation of the drum 11 can be controlled to orient the material port 113 of the drum 11 differently for allowing material to be loaded or unloaded. Particularly, the material port 113 faces upward for material loading, and downward for material unloading.

The rotatory shaft 111 is a solid, columnar structure made of titanium alloy or other acid-proof metals and alloy materials thereof When the hoisting device 40 moves the batch-containing device 10, the rotatory shaft 111 is the major force-bearing component throughout the hoisting process. The rotatory shaft 111 has its one end provided with a transmission gear 1111, and the drive motor 12 is provided with a matching drive motor gear 121. With engagement between the transmission gear 1111 and the drive motor gear 121, the drive motor 12 drives the rotatory shaft 111 to rotate, thereby rotating the drum 11.

Besides, both ends of the rotatory shaft 111 are provided with rolling bearings 1112 and hoisting elements 1113. The hoisting elements 1113 and the hoisting devices 40 are in movable and coordinative connection. In the present embodiment, the hoisting elements 1113 are bearings mounted around the rotatory shaft, and have a diameter not greater than the diameter of the hooks of the hoisting device 40. The rolling bearings 1112 serve to reduce drag against rotation of the drum 11. As shown in FIG. 2, along the rotatory shaft 111, there are transmission gear 1111, hoisting element 1113, rolling bearing 1112, body of the drum 11, rolling bearing 1112, and hoisting element 1113 from left to right in sequence.

The hoisting device 40 adopts the structure of any known crane. In the present embodiment, it includes a hoisting motor, a hoisting controller, and a hoisting unit. The hoisting controller is a programmable logic controller. The controller controls the hoisting motor to drive the hoisting unit to move, so as to make the batch-containing device 10 move between and within the pickling area 20 and the water-rinse area 30. The hoisting device 40 lifts the drum 11 by means of the hoisting elements 1113 at the two ends of the rotatory shaft 111 and aids the drum 11 to perform operations of material-loading, entering the pickling area, exiting the pickling area, entering the water-rinse area, and exiting the water-rinse area in sequence.

The magnesium alloy waste material is filled in the drum 11 through the batch-containing device 10, and placed into the pickling area 20 and the water-rinse area 30 by the hoisting device 40 for pickling and water-rinse. For ensuring that the magnesium alloy waste material sufficiently contacts washing liquid in the pickling and water-rinse processes, the inventor basing on any of the foregoing configurations of the pickling production line, makes structural improvement in the pickling area 20 and the water-rinse area 30 to adapt them to the batch-containing device 10. The magnesium alloy waste material sufficiently contacts acid liquid in the pickling process to have oxide layers and impurities removed from its surface. In the water-rinse process, double water-rinse is performed to thoroughly remove residual acid and residue from the magnesium alloy waste material's surface.

The magnesium alloy waste material is pickled in the pickling area 20 through the batch-containing device 10. The pickling area 20 includes a pickling bath 21, an acid-in channel 22, and an acid-out channel 23. The acid-out channel 23 passes through the pickling bath's lateral wall and the acid-out channel 23 has its wall tangent to the pickling bath's bottom. The acid-in channel 22 passes through the pickling bath's lateral wall. The acid-in channel 22 is higher than the acid-out channel 23 in altitude. The acid-in channel 22 and the acid-out channel 23 control charging and discharging of acid solution to and from the pickling bath 21. The acid-in channel 22 is a double acid-in channel. The double acid-in channel includes two side tubes extending from the same main tube. The two side tubes pass through different lateral walls of the pickling bath 21, respectively. Preferably, the two side tubes are disposed at two opposite lateral walls of the pickling bath, so that during acid charging the acid solution in the pickling bath 21 can be prepared more homogeneous.

The pickling bath 21 is made of engineering plastic or fiber-reinforced plastic. The pickling bath 21 has a pickling bath lid to close the bath as a pickling room to preventing volatilization of acid solution in the pickling bath 21 when the pickling bath 21 is not in use (having no batch-containing device therein), thereby reducing loss of material and preventing atmospheric pollution. The pickling bath 21 and the drum 11 match each other in size. The dimension of the pickling bath 21 in its length direction is 20 to 50 cm greater than the dimension of the drum 11 in its height direction. The dimension of the pickling bath 21 in its width direction is 20 to 100 cm greater than the diameter of the drum 11. The dimension of the pickling bath 21 in its height direction is 10 to 100 cm greater than the radius of the drum 11.

The pickling bath 21 has its two sides provided with pickling force-bearing seats 211. The two pickling force-bearing seat 211 are such installed that they are coaxial with the center line of the pickling bath 21. When the drum 11 is in the pickling bath 21, the two rotating bearings 1112 on the rotatory shaft 111 are settled in the two pickling force-bearing seats 211, respectively, thereby securing the relative position between the drum 11 and the pickling bath 21 unchanged and reducing drag against rotation of the drum 11.

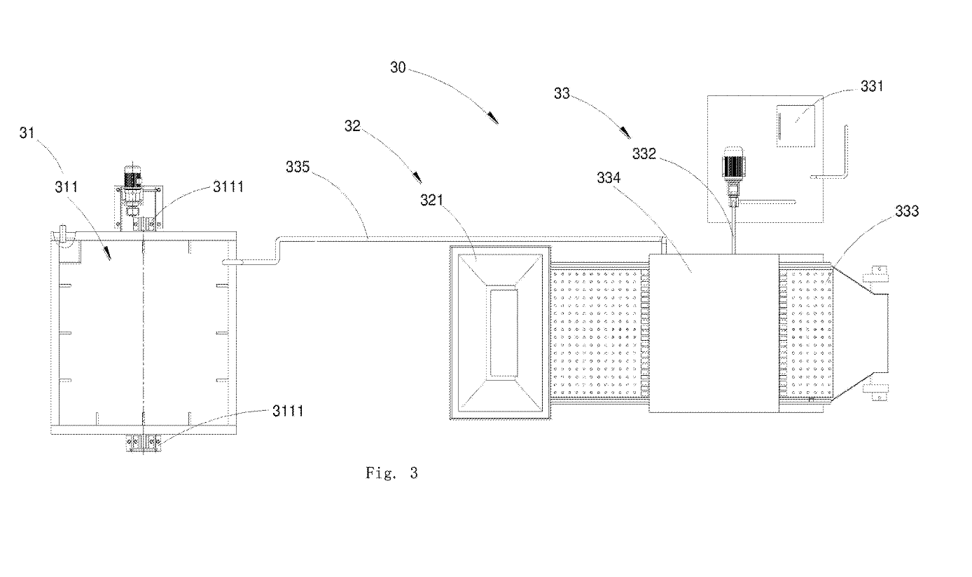

FIG. 3 schematically depicts the water-rinse area in the pickling production line for magnesium alloy waste material of the present invention. After the drum 11 of the batch-containing device 10 receives pickling in the pickling bath 21 in the pickling area 20, the hoisting device 40 lifts the drum 11 by means of the two hoisting elements 1113 on the rotatory shaft 111 and moves it to the water-rinse area 30 for water-rinse. As shown in FIG. 3, the water-rinse area 30 includes a rinse unit 31, a material unloading unit 32, and a spraying unit 33. The pickled magnesium alloy waste material in the water-rinse area 30 is processed by the rinse unit 31, the material unloading unit 32, and the spraying unit 33 in sequence. The rinse unit 31 and the spraying unit 33 wash the magnesium alloy waste material. Thus, the pickled magnesium alloy waste material receives two kinds of wash, namely rinse and sprinkling, in the water-rinse area 30, so as to have residual acid and residue removed from its surface thoroughly.

When the drum 11 is moved to the water-rinse area 30 from the pickling bath 21 by the hoisting device 40, the drum 11 first enters the rinse unit 31. The first water-rinse of the magnesium alloy waste material is performed in the rinse unit 31 for primarily removing residual acid and residue from the magnesium alloy waste material's surface. The rinse unit 31 further includes a rinse bath 311. As the drum 11 rotates in the rinse bath 311, the magnesium alloy waste material is rinsed. The rinse bath 311 and the drum 11 match each other in size. The rinse bath 311 has an area smaller than the area of the pickling bath 21 in the pickling area 20. The area of the rinse bath 311 is greater than the horizontal section area of the drum 11. The rinse bath 311 has a depth greater than the radius of the drum 11, thereby allowing smooth rotation of the drum 11 in the rinse bath 311.

The rinse bath 311 has two ends thereof each provided with a rinse force-bearing seat 3111. The two rinse force-bearing seats 3111 are such installed that they are coaxial with the center line of the rinse bath 311. When the drum 11 is in the rinse bath 311 for rinse, the two rotating bearings 1112 on the rotatory shaft 111 are settled in the two rinse force-bearing seats 3111, thereby securing the relative position between the drum 11 and the rinse bath 311 unchanged, and reducing drag against rotation of the drum 11.

After the magnesium alloy waste material in the drum 11 is rinsed in the rinse bath 311, the hoisting device 40 uses the two hoisting elements 1113 on the rotatory shaft 111 to lift the drum 11 and move it to the material unloading unit 32. The material unloading unit 32 includes a discharge hopper 321. When the drum 11 is moved from the rinse bath 311 to the material unloading unit 32 by the hoisting device 40, the drum 11 with the assistance of the hoisting device 40, pours the magnesium alloy waste material into the discharge hopper 321 and thus accomplishes the operation of material unloading.

The spraying unit 33 and the material unloading unit 32 are connected to each other. The magnesium alloy waste material receives the secondary water-rinse in the spraying unit 33, to further remove residual acid and residue left on the magnesium alloy waste material's surface. The spraying unit 33 includes a water pressurizer 331, water nozzles 332, a spraying conveyer 333, and a spraying hood 334. The discharge hopper 321 is disposed at one end of the spraying conveyer 333. The magnesium alloy waste material unloaded from the discharge hopper 321 is laid evenly on the spraying conveyer 333 and conveyed by the spraying conveyer 333. The water nozzles 332 and the water pressurizer 331 are connected. The magnesium alloy waste material is water-rinsed again in the spraying unit 33 by the water nozzles 332. The water nozzles 332 and the water pressurizer 331 are disposed at one side of the spraying conveyer 333. The spraying hood 334 is a three-side hood and covers the spraying conveyer 333 at its two laterals and top, so as to prevent the magnesium alloy waste material from coming off the spraying conveyer 333 when hit by water from the water nozzles 332, thereby reducing material wasting. The spraying conveyer 333 is a vibrating conveyer board. In the present embodiment, the conveyer board is electrically connected to a vibration motor, and is meshed and sloping. This not only allows water from the water nozzles 332 to permeate in the magnesium alloy waste material in the sprinkling process, but also makes the material on the vibrating conveyer board move forward evenly under vibration, thereby preventing the material from being piled on the spraying conveyer. The conveyer board has a slope of 10 degrees. The sprinkling conveyer has its two sides equipped with retaining plates for retaining the material from falling.

The spraying unit 33 further includes a collecting tube 335. The collecting tube 335 has its one end disposed below the spraying conveyer 333, and an opposite end communicated with the rinse bath 311 of the rinse unit 31. The collecting tube 335 collects waste water generated in the sprinkling process and uses it as a part of the aqueous solution in the rinse bath 311. Such recycling and reuse of the waste water in the sprinkling process is helpful to conserve resources.

After finished material unloading in the water-rinse area 30, the drum 11 in the batch-containing device 10 is moved by the hoisting device 40 to the initial stage and gets ready for the next round of operations of material-loading, entering the pickling bath, exiting the pickling bath, entering the rinse bath, exiting the rinse bath and material unloading.

For ensuring safety in the subsequent processes, and reducing the reject rate of reprocessing of the magnesium alloy waste material, the inventor of the present invention adds the pickling production line with a dewatering-drying device, so as to quickly evaporate liquid left on the magnesium alloy waste material's surface, thereby ensuring the magnesium alloy waste material's safety in the subsequent processes, reducing gas inclusion, and decreasing the reject rate of reprocessing of the magnesium alloy waste material.

As shown in FIG. 1, the dewatering-drying device 60 is disposed at the rear end of the water-rinse area 30. The dewatering-drying device 60 is connected to the rear end of the spraying conveyer 333 of the spraying unit 33 of the water-rinse area 30. The dewatering-drying device 60 includes an air-blowing unit 61 and a hot-air drying unit 62. The air-blowing unit 61 and the hot-air drying unit 62 are connected together. The air-blowing unit 61 is connected to the spraying unit 33 of the water-rinse area 30. After the magnesium alloy waste material washed by the spraying unit 33 in the water-rinse area 30 then passes through the air-blowing unit 61 and the hot-air drying unit 62 in sequence for dewatering and desiccation, so as to evaporate liquid from the magnesium alloy waste material's surface with increased speed, thereby ensuring the magnesium alloy waste material's safety in the subsequent processes and reducing gas inclusion.

The air-blowing unit 61 may be one known in the art that includes an air-blowing compressor, an air-blowing conveyer, an air-blowing nozzle, and an air-blowing hood. The air-blowing hood is a three-side hood and covers the air-blowing conveyer's two laterals and top. The air-blowing nozzles are arranged above the air-blowing conveyer and inside the air-blowing hood. The air-blowing conveyer has its one end connected to the spraying unit in the water-rinse area, and has its opposite end connected to the hot-air drying unit. The air-blowing compressor supplies the air-blowing nozzles with pressurized air. The magnesium alloy waste material in the air-blowing unit is transferred by the air-blowing conveyer and treated by the compressed air gushing from the air-blowing nozzles, so as to have liquid at is surface preliminarily removed, thereby reducing working load in the hot-air drying process.

The hot-air drying unit 62 is also known in the art and includes a hot-air compressor, a heat source, hot-air nozzles, heat-baking conveyer and heat-baking hood. The heat-baking hood is a three-side hood and covers the heat-baking conveyer's two laterals and top. The hot-air compressor and the heat source are connected. The hot-air nozzles are disposed above the heat-baking conveyer and inside the heat-baking hood. The heat-baking conveyer has its one end connected to the air-blowing unit's air-blowing conveyer. The hot-air drying unit works as below. The pressurized air generated by the hot-air compressor is heated by the heat source into pressurized hot air. The hot-air compressor generates hot air and makes it gush from the hot-air nozzles. The magnesium alloy waste material transferred by the heat-baking conveyer is dried by the pressurized hot air coming from the hot-air nozzles, so as to evaporate liquid at the magnesium alloy waste material's surface quickly. Therein, the heat source may be one known in the art, such as electric heating or gas heating, as long as it is as energy-conserving and environmentally friendly as possible.

The hot-air drying unit 62 further includes an air extractor. The air extractor is disposed at one side of the heat-baking conveyer for quickly exhausting the gas at the magnesium alloy waste material's surface after evaporation, thereby preventing gas condensation and secondary contamination.

It is to be noted that, the air-blowing conveyer in the air-blowing unit 61 and the heat-baking conveyer in the hot-air drying unit 62 are both meshed conveyers, so as to facilitate ventilation and water permeation in the magnesium alloy waste material when transferred in the air-blowing unit 61 and the hot-air drying unit 62. The mesh of the meshed conveyer is smaller than the magnesium alloy waste material's minimum lump diameter.

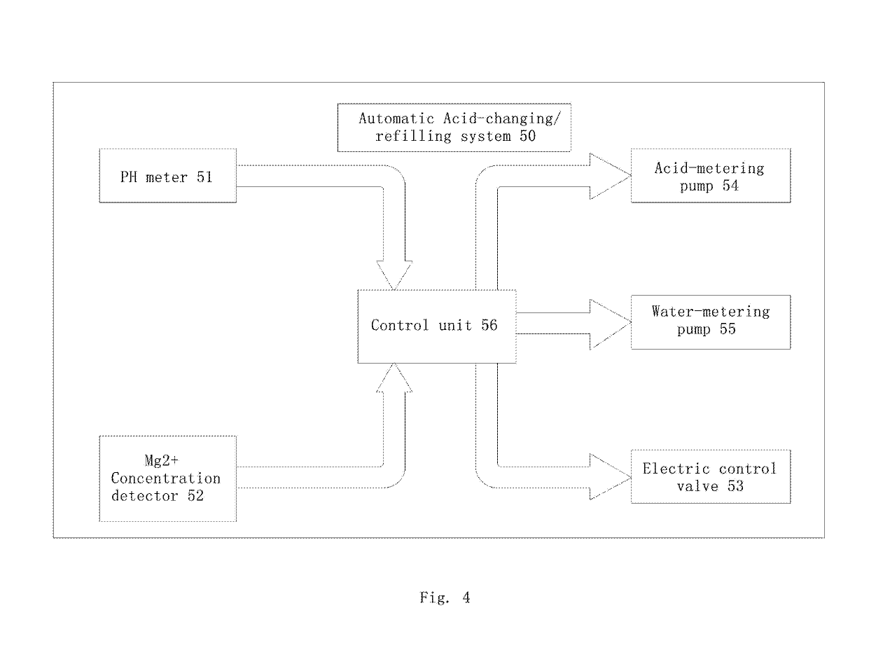

FIG. 4 is a flowchart of an automatic acid-changing/refilling system in the pickling production line for magnesium alloy waste material according to the present invention. As shown in FIG. 4, for maintaining the acid liquid concentration in a predetermined range throughout the magnesium alloy waste material's pickling process, so as to ensure desired pickling intensity and pickling effectiveness, the inventor of the present invention adds an automatic acid-changing/refilling system 50 in the pickling production line, which monitors variation of the acid liquid throughout the pickling process and automatically adds or changes acid, thereby maintaining the acid liquid concentration and in turn the pickling effectiveness.

As shown in FIG. 4, the automatic acid-changing/refilling system 50 includes a pH meter 51, an Mg²⁺ concentration detector 52, an electric control valve 53, an acid-metering pump 54, a water-metering pump 55, and a control unit 56. Therein, the pH meter 51, the Mg²⁺ concentration detector 52, and the electric control valve 53 are partially disposed inside the pickling bath 21, while the acid-metering pump 54, the water-metering pump 55, and the control unit 56 are partially disposed outside the pickling bath 21. The pH meter 51, the Mg²⁺ concentration detector 52, the electric control valve 53, the acid-metering pump 54, and the water-metering pump 55 are in data connection with the control unit 56, and are connected in parallel to each other in the present embodiment. Accordingly, the electric control valve 53 controls acid discharging of the acid-out channel 23, and the acid-metering pump 54 controls acid charging of the acid-in channel 22. The pH meter 51, the Mg²⁺ concentration detector 52, electric control valve 53, the acid-metering pump 54, and the water-metering pump 55 are connected to the control unit 56. The pH meter 51 regularly measures acidity of the acid solution in the pickling bath 21, and the Mg²⁺ concentration detector 52 measures Mg²⁺ concentration in the pickling bath 21 in a real-time manner. The pH meter 51 and the Mg²⁺ concentration detector 52 send signals to the control unit 56 according to their measurement. The control unit 56 controls operations of the electric control valve 53, the acid-metering pump 54, and the water-metering pump 55.

When a pH value measured by the pH meter 51 is below a predetermined pH threshold (>7), the control unit 56 receives the signals so as to start the acid-metering pump 54 and open the acid-in channel 22 to add the pickling bath 21 with acid. When a detected value of the Mg²⁺ concentration detector 52 is over a predetermined Mg²⁺ concentration threshold, the control unit 56 receives the signals so as to open the electric control valve 53 and open the acid-out channel 23 for automatic acid discharge, after which the electric control valve 53 is closed while the control unit 56 starts the acid-metering pump 54 and the water-metering pump 55 to prepare the acid solution again according to a predetermined ratio. By regularly measuring the pH value and Mg²⁺ concentration in the pickling bath 21 and automatically adding or changing acid, the acid liquid concentration and Mg²⁺ concentration can be maintained in a predetermined range, thereby ensuring pickling effectiveness.

In the whole pickling production line, waste acid and waste gas will be generated during pickling the magnesium alloy waste material in the pickling bath 21. For reducing environmental pollution and conserving resources, the inventor of the present invention, on the basis of any of the foregoing configurations of the pickling production line, adds an environmental protection system 70 to process waste gas and waste acid generated throughout the pickling production line, so as to protect the environment and conserve resources.

The environmental protection system 70 includes a waste-gas processing unit 71, and a waste-acid processing unit 72, which units are independently arranged, recycle and process waste gas and waste acid generated in the entire pickling production line, respectively, thereby achieving zero discharge of the pickling production line.

The exhaust-processing unit 71 can be any known waste gas recycling arrangement in the art. In the present mode, the exhaust-processing unit 71 is an acid-gas spray column serves to process acid gas. The acid-gas spray column includes a blower, filler, a spraying device, a defogging device, a sprinkling liquid circulating pump, and an absorption column. It neutralizes acid gas to eliminate emission of acid gas, and thus provides environmentally friendly processing to the waste gas. In addition, the waste-gas processing unit 71 further includes an airtight glass chamber (not shown in the figure). The exhauster is disposed inside the glass chamber. The exhauster draws the acid gas in the glass chamber into the acid-gas spray column. The rinse units 31 in the pickling area 20 and the water-rinse area 30 are both disposed inside the glass chamber, wherein the area of the glass chamber is not smaller than a sum area of the pickling area and the rinse unit. The glass chamber has a batch-in gate, a batch-out gate, and a control sensor. The control sensor opens or closes the batch-in gate and the batch-out gate. When magnesium alloy waste material as the raw material enters the pickling production line, the batch-in gate opens automatically, and automatically closes when material loading is finished. When magnesium alloy waste material as the raw material has been processed by the entire pickling production line and outputs, the batch-out gate opens automatically and closes automatically when output ends.

The waste-acid processing unit 72 can be any known waste acid recycling arrangement in the art. In the present mode, the waste-acid processing unit 72 includes a neutralization pit, a filter, an evaporation crystallizer, and a drier connected in sequence. Therein, the neutralization pit and the acid-out channel 23 are communicated. Waste acid in the pickling area 20 is processed by the neutralization pit, the filter, the evaporation crystallizer, and the drier in sequence and converted into dry magnesium salts, so as to eliminate waste acid discharge, to protect the environment, and to conserve resources.

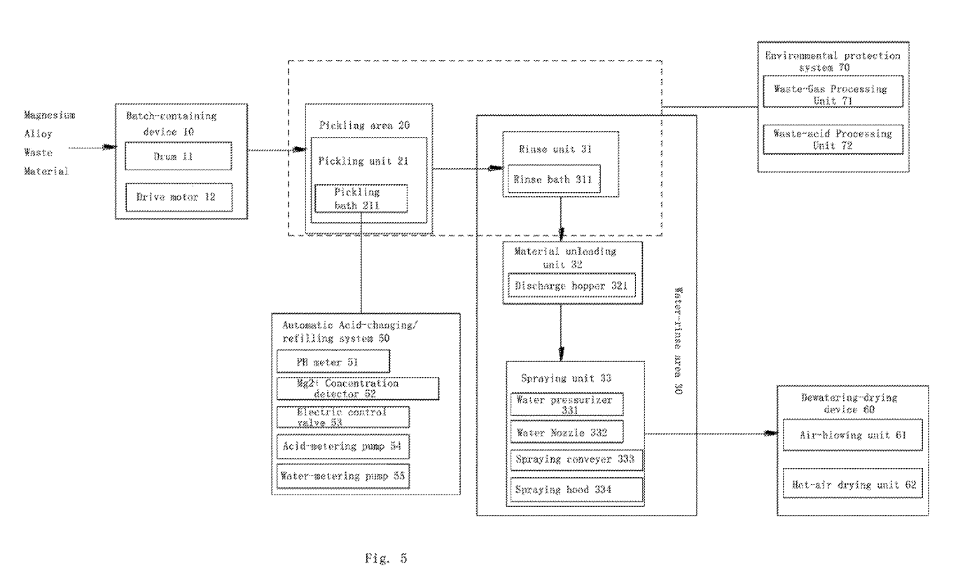

FIG. 5 is a flowchart of the pickling production line for magnesium alloy waste material of the present invention. As shown in FIG. 5, the pickling production line includes a batch-containing device 10, a pickling area 20, a water-rinse area 30, a hoisting device 40, an automatic acid-changing/refilling system 50, a dewatering-drying device 60 and an environmental protection system 70. The automatic acid-changing/refilling system 50 maintains acid liquid in the pickling area 20 at certain concentration. The pickling area 20 and the water-rinse area 30 are separated. The batch-containing device 10 serves to contain the magnesium alloy waste material. The hoisting device 40 moves the batch-containing device 10 between the pickling area 20 and the water-rinse area 30. The dewatering-drying device 60 dries the magnesium alloy waste material that has been processed in the pickling area 20 and the water-rinse area 30. The environmental protection system 70 processes waste gas and waste acid generated throughout the pickling production line.

The travel of the magnesium alloy waste material is described below. The magnesium alloy waste material is loaded into the drum 11 of the batch-containing device 10. The hoisting device 40 uses the two hoisting elements 1113 on the rotatory shaft 111 to lift the drum 11 and moves it to the pickling area 20. The two rotating bearings 1112 on the rotatory shaft 111 are settled on the two pickling force-bearing seats 211 of the pickling bath 21, respectively. The drum 11 is placed into pickling bath 21. The transmission gear 1111 of the rotatory shaft 111 and the motor gear 121 of the drive motor 12 engage with each other. The drive motor 12 drives the rotatory shaft 111 to rotate, and thereby the drum 11 rotates in the pickling bath 21. The magnesium alloy waste material in the drum 11 randomly rolls as the drum 11 rotates, thereby ensuring sufficient contact between the magnesium alloy waste material and the acid liquid. Meanwhile, impurities attached to the surface of the magnesium alloy waste material (especially those in grooves) are more likely to come off in the rolling process, thereby harmful impurities on the surface of the magnesium alloy waste material are removed. After pickling, the drum 11 is placed into the rinse unit 31 of the water-rinse area 30 by the hoisting device 40. The two rotating bearings 1112 of the rotatory shaft 111 are settled in the two rinse force-bearing seats 3111, respectively. The drum 11 is placed into the rinse bath 311, and the drive motor 12 drives the rotatory shaft 111 to rotate and thus drives the drum 11 to rotate for rinse. The magnesium alloy waste material in the drum 11 rolls randomly with the drum 11, thereby ensuring sufficient contact between magnesium alloy waste material and water. The magnesium alloy waste material receives first water-rinse in the rinse bath 311 for preliminarily removing residual acid and residue on the magnesium alloy waste material's surface. After rinse, the drum 11 is moved by the hoisting device 40 and placed into the material unloading unit 32. The drum 11 performs material unloading via the discharge hopper 321 with the assistance of the hoisting device 40. The spraying conveyer 333 of the spraying unit 33 has one end thereof disposed below the discharge hopper 321. The magnesium alloy waste material unloaded from the discharge hopper 321 is laid evenly on the spraying conveyer 333. The spraying conveyer 333 conveys it to a place below the water nozzles 332. The water nozzles 332 sprinkle water on the magnesium alloy waste material on the spraying conveyer 333. The magnesium alloy waste material is thus washed for a second time by the spraying unit 33, so as to further clean residual acid and residue left on the magnesium alloy waste material's surface. After the magnesium alloy waste material receives water-rinse through the entire water-rinse area 30, it is transferred to the dewatering-drying device 60. In the dewatering-drying device 60, the air-blowing unit 61 preliminarily removes liquid on the magnesium alloy waste material's surface, and the hot-air drying unit 62 provides secondarily drying by hot-air, thereby obtaining dry magnesium alloy waste material with its surface stripped.

When transferring the magnesium alloy waste material by the drum 11 of the batch-containing device 10 between the pickling area 20 and the water-rinse area 30, the drum 11 performs material loading, entering the pickling area, exiting the pickling area, entering the water-rinse area, exiting the water-rinse area and material unloading in sequence with help of the batch-containing device 40.

In addition, the pickling bath 21 of the pickling area 20 is provided with an acid-changing/refilling system 50. In the acid-changing/refilling system 50, a pH meter 51 and a the Mg²⁺ concentration detector 52 regularly measure acidity and Mg²⁺ concentration in the pickling bath 21. When the acidity and the Mg²⁺ concentration are out of the predetermined range, the control unit 56 controls operations of the electric control valve 53, the acid-metering pump 54, and the water-metering pump 55 to add or change acid in the pickling bath 21.

The waste acid and waste gas are processed by the environmental protection system 70. The exhaust-processing unit 71 in the environmental protection system 70 gathers waste gas into the glass chamber and exhaust into an alkali pit for neutralization, so as to prevent pollution to the environment. Waste acid is processed by the neutralization pit, the filter, the evaporation crystallizer, and the drier in the waste-acid processing unit 72 in sequence and converted into dry magnesium salts, so as to eliminate waste acid discharge, to protect the environment, and to conserve resources.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A pickling production line for magnesium alloy waste material, being characterized in comprising: a batch-containing device, a pickling area, and a water-rinse area,
wherein the batch-containing device contains the magnesium alloy waste material, and the pickling area is independent of the water-rinse area; and
wherein the material travels in the pickling production line in such manner: after fed into the batch-containing device, the magnesium alloy waste material is sent by the batch-containing device to the pickling area and the water-rinse area for pickling and water rinse in sequence.

2. A pickling production line for magnesium alloy waste material, being characterized in comprising: a batch-containing device, a pickling area, a water-rinse area, and a hoisting device,
wherein the batch-containing device contains the magnesium alloy waste material, and the pickling area is independent of the water-rinse area, and the hoisting device drives the batch-containing device to travel between the pickling area and the water-rinse area; and
wherein the material travels in the pickling production line in such manner: after feeding the magnesium alloy waste material into the batch-containing device, the batch-containing device driven by the hoisting device enters the pickling area and the water-rinse area in sequence for pickling and water rinse respectively.

3. The pickling production line of claim 2, wherein the magnesium alloy waste material is discarded magnesium alloy products.

4. The pickling production line of claim 2, wherein the magnesium alloy waste material is pickled in the pickling area and rinsed in the water-rinse area, respectively, as the batch-containing device rotates.

5. The pickling production line of claim 2, wherein the batch-containing device is a power-driven drum, which contains the magnesium alloy waste material and is provided with a rotatory shaft passing through and fixedly connected to the drum.

6. The pickling production line of claim 5, wherein the drum is provided with a plurality of through holes, whose diameter is smaller than a lump diameter of the magnesium alloy waste material.

7. The pickling production line of claim 5, wherein the rotatory shaft has two ends thereof each provided with a hoisting element cooperatively and movably connected to the hoisting device.

8. The pickling production line of claim 2, wherein the hoisting device is a power-driven hoisting unit equipped with hooks, which hooks work with the hoisting elements of the batch-containing device to drive the batch-containing device to perform the operations of loading material, entering the pickling area, exiting the pickling area, entering the water-rinse area, exiting the water-rinse area or unloading material in sequence.

9. The pickling production line of claim 2, wherein the pickling area includes a pickling bath, an acid-in channel, and an acid-out channel,
wherein the acid-in channel and the acid-out channel pass through the pickling bath and get communicated with the pickling bath, respectively.

10. The pickling production line of claim 2, wherein the water-rinse area includes a rinse unit, a material unloading unit and a spraying unit,
wherein the pickled magnesium alloy waste material passes through the rinse unit, the material unloading unit, and the spraying unit in sequence, so that the rinse unit and the spraying unit perform double water rinse on the magnesium alloy waste material.

11. The pickling production line of claim 10, wherein the pickling bath or the rinse bath has two ends thereof each provided with a force-bearing seat, and the force-bearing seats are coaxial with a center line of the rinse bath in a length direction thereof

12. The pickling production line of claim 10, wherein the spraying unit includes a water pressurizer, a water nozzle, a spraying conveyer, and a spraying hood,
wherein the water nozzles and the water pressurizer are disposed at one side of the spraying conveyer and are connected with each other, and the magnesium alloy waste material in the spraying unit is rinsed again by the water nozzle, and
wherein the spraying hood is a three-side hood covering the spraying conveyer's two laterals and top.

13. The pickling production line of claim 12, wherein the spraying conveyer is a vibrating conveyer board.

14. The pickling production line of claim 10, the material unloading unit is disposed at one end of the spraying unit, and the magnesium alloy waste material is unloaded from the discharge hopper material and transferred by the spraying conveyer to enter the spraying unit for secondary water-rinse.

15. The pickling production line of claim 2, wherein the pickling line further comprises a dewatering-drying device, for dewatering and desiccating the pickled and water-rinsed material,
wherein the dewatering-drying device includes an air-blowing unit and a hot-air drying unit that are connected to but not communicated with each other, in which the air-blowing unit is connected to the spraying unit of the water-rinse area, and the magnesium alloy waste material processed by the spraying unit passes through the air-blowing unit and the hot-air drying unit in sequence for dewatering and desiccation.

16. The pickling production line of claim 2, wherein the pickling production line for magnesium alloy waste material further comprises an automatic acid-changing/refilling system, which system includes a pH meter, an Mg2+ concentration detector, an electric control valve, an acid-metering pump, a water-metering pump, and a control unit,
wherein the portion of the pH meter, the Mg2+ concentration detector, and the electric control valve are disposed inside the pickling bath, while the portion of the acid-metering pump, the water-metering pump, and the control unit are disposed outside the pickling bath;
wherein the pH meter, the Mg2+ concentration detector, the electric control valve, the acid-metering pump, and the water-metering pump are in data connection with the control unit,
wherein the pH meter serves to regularly measure acidity of an acid solution in the pickling bath, the Mg2+ concentration detector serves to measure Mg2+ concentration in the pickling bath in a real-time manner, the pH meter and the Mg2+ concentration detector send signals to the control unit according to their measurement for controlling operations of the electric control valve, the acid-metering pump, and the water-metering pump by the control unit;
wherein the electric control valve controls acid discharging via the acid-out channel, and the acid-metering pump controls acid charging via the acid-in channel.

17. The pickling production line of claim 16, wherein when a pH value measured by the pH meter is below a predetermined pH threshold, the control unit after received the signals starts the acid-metering pump and opens the acid-in channel to add the pickling bath with acid, wherein the pH value ranges between 0 and 7.

18. The pickling production line of claim 16, wherein when a detected value of the Mg2+ concentration detector is over a predetermined Mg2+ concentration value, the control unit after received the signals opens the electric control valve and opens the acid-out channel for automatic acid discharge, after the discharge the electric control valve is closed, while the control unit starts the acid-metering pump and the water-metering pump to prepare the acid solution again according to a predetermined ratio, wherein the Mg2+ concentration ranges between 0.0 and 3.0 mol/L.

19. The pickling production line of claim 2, wherein the pickling production line further comprises a environmental protection system including a waste-gas processing unit and a waste-acid processing unit, which units are independent of each other, so that the waste-gas processing unit and the waste-acid processing unit process waste gas and waste acid generated in the entire pickling line, respectively.

20. Use of the pickling production line for magnesium alloy waste material according to claim 1, wherein the pickling production line combines with a post processing system for magnesium alloy waste material to becomes a recycling and processing production line for magnesium alloy waste material, wherein the pickling production line is used for pickling and removing impurities on the surface of the magnesium alloy waste material.
